(19) United States
(12) Patent Application Publication
(10) Pub. No.: US 2025/0309530 A1
(43) Pub. Date: Oct. 2, 2025

(54) WIRELESS DEVICE AND ELECTRONIC DEVICE

(71) Applicant: Lenovo (Beijing) Limited, Beijing (CN)

(72) Inventors: Wenlei WANG, Beijing (CN); Meijin GUO, Beijing (CN)

(21) Appl. No.: 19/080,651

(22) Filed: Mar. 14, 2025

(30) Foreign Application Priority Data
Mar. 29, 2024 (CN) 202410383081.1

(51) Int. Cl. H01Q 1/52; H01Q 9/04

(52) U.S. Cl. CPC H01Q 1/521; H01Q 9/0407

(57) ABSTRACT

A wireless device including at least two antennas, the at least two antennas being arranged at intervals along a preset direction; and at least two groups of isolating members, the at least two groups of isolating members being arranged between two adjacent antennas, the at least two groups of isolating members being arranged at intervals along the preset direction to reduce coupling of electromagnetic waves between the at least two antennas.

### CROSS-REFERENCES TO RELATED APPLICATION

This application claims priority to Chinese Patent Application No. 202410383081.1 filed on Mar. 29, 2024, the entire content of which is incorporated herein by reference.

### FIELD OF TECHNOLOGY

The present disclosure relates to the field of wireless device technology and, more specifically, to a wireless device and an electronic device.

### BACKGROUND

Electronic devices are generally equipped with wireless devices such that the electronic devices can send and receive wireless signals through the wireless devices. In related art, due to the limitation of installation space, the distance between adjacent antennas in the wireless device is relatively close. This design will enhance the coupling of electromagnetic waves between antennas, reduce the isolation between antennas, and thus affect the performance of the wireless device.

### SUMMARY

One aspect of this disclosure provides a wireless device. The wireless device includes at least two antennas, and at least two groups of isolating members. The at least two antennas are arranged at intervals along a preset direction. The at least two groups of isolating members are arranged between two adjacent antennas. The at least two groups of isolating members are arranged at intervals along the preset direction to reduce coupling of electromagnetic waves between the at least two antennas.

Another aspect of this disclosure provides an electronic device. The electronic device includes a housing and a wireless device. The wireless device includes at least two antennas, and at least two groups of isolating members. The at least two antennas are arranged at intervals along a preset direction. The at least two groups of isolating members are arranged between two adjacent antennas. The at least two groups of isolating members are arranged at intervals along the preset direction to reduce coupling of electromagnetic waves between the at least two antennas.

### BRIEF DESCRIPTION OF THE DRAWINGS

FIG. 1 is a schematic structural diagram of an example electronic device according to some embodiments of the present disclosure.

FIG. 2 is a schematic structural diagram of a first example wireless device according to some embodiments of the present disclosure.

FIG. 3 is a top view of a dielectric substrate and a first isolating member in shown

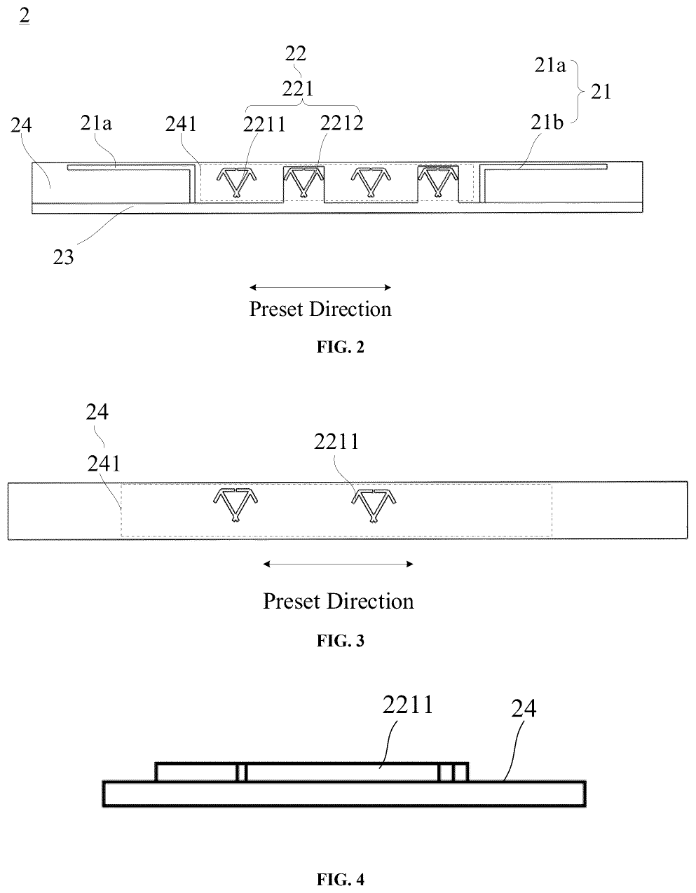

FIG. 2 according to some embodiments of the present disclosure.

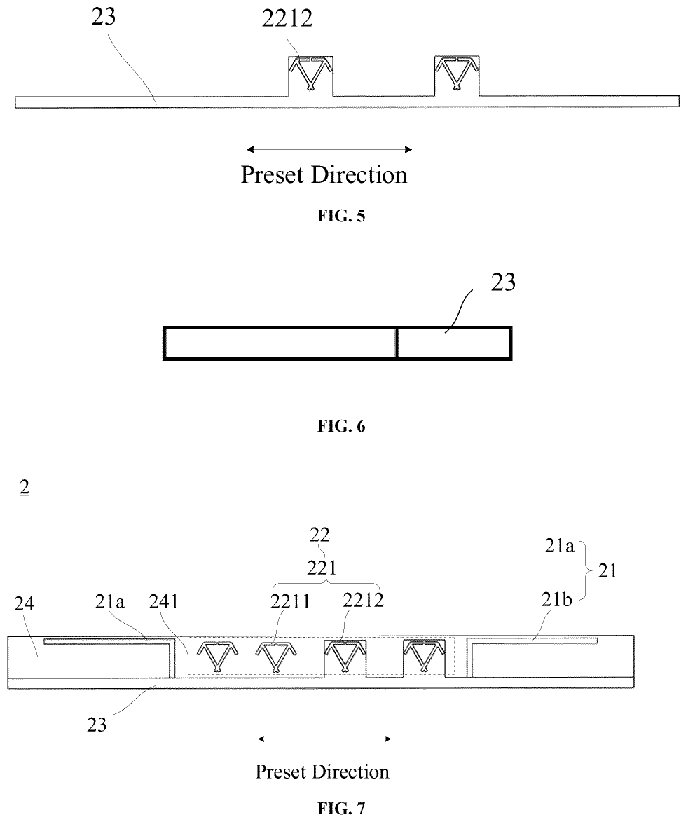

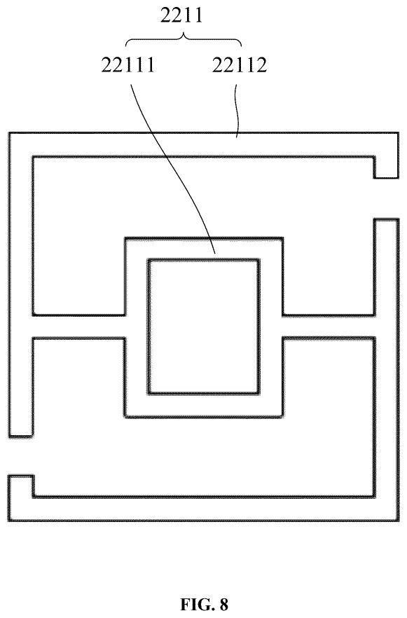

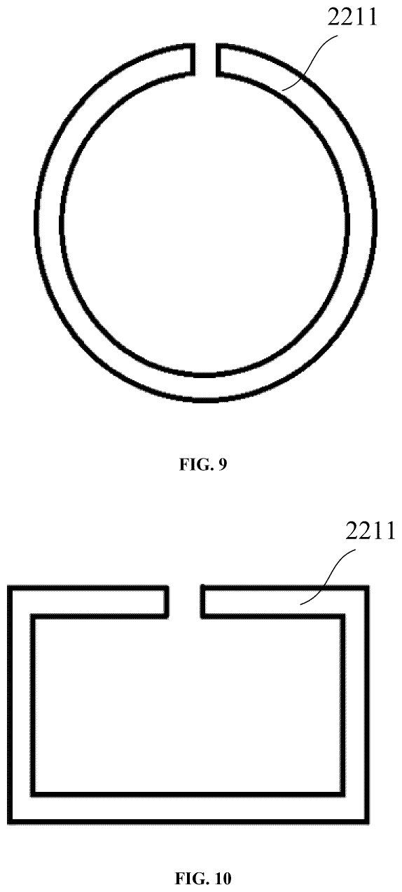

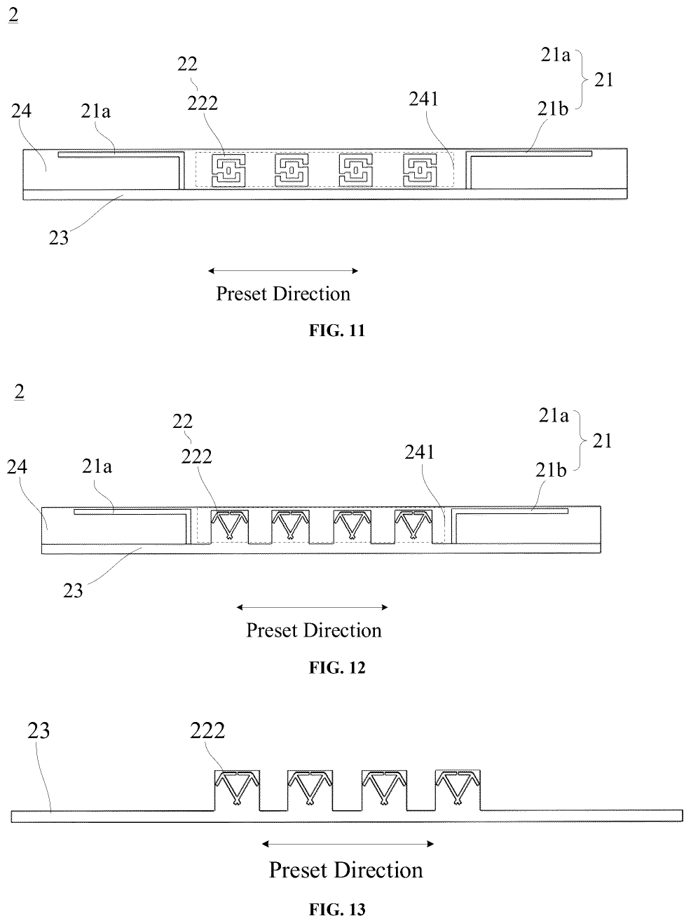

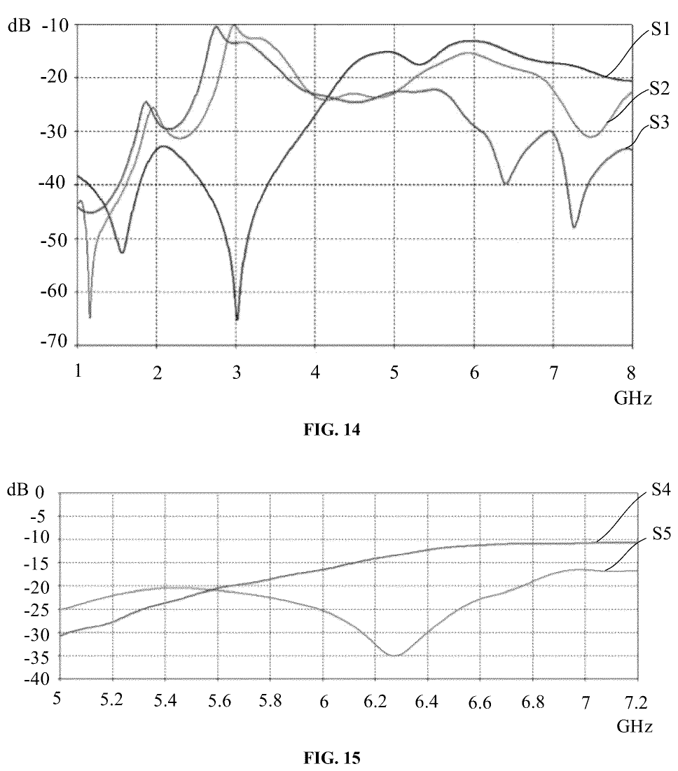

FIG. 4 is a side view of FIG. 3.

FIG. 5 is a top view of a conductive member and a second isolating member shown in FIG. 2 according to some embodiments of the present disclosure.

FIG. 6 is a side view of FIG. 5.

FIG. 7 is a schematic structural diagram of a second example wireless device according to some embodiments of the present disclosure.

FIG. 8 is a schematic structural diagram of a first example first isolating member according to some embodiments of the present disclosure.

FIG. 9 is a schematic structural diagram of a second example first isolating member according to some embodiments of the present disclosure.

FIG. 10 is a schematic structural diagram of a third example first isolating member according to some embodiments of the present disclosure.

FIG. 11 is a schematic structural diagram of a third example wireless device according to some embodiments of the present disclosure.

FIG. 12 is a schematic structural diagram of a fourth example wireless device according to some embodiments of the present disclosure.

FIG. 13 is a top view of the conductive member and the second isolating member shown in FIG. 12 according to some embodiments of the present disclosure.

FIG. 14 is a schematic diagram showing a comparison of the isolation effects of the first isolating structure and a second isolating structure according to some embodiments of the present disclosure.

FIG. 15 is a schematic diagram showing a comparison of the isolation effects of second isolating structures of different sizes according to some embodiments of the present disclosure.

### DETAILED DESCRIPTION

It should be noted that, without conflict, embodiments and technical features in the embodiments can be combined with each other. Detailed descriptions in specific embodiments should be understood as an explanation of the gist of the present disclosure and should not be regarded as undue limitation of the present disclosure.

To make the purpose, technical solutions, and advantages of some embodiments of the present disclosure clearer, specific technical solutions of the present disclosure will be further described in detail below in conjunction with accompanying drawings in some embodiments of the present disclosure. The following examples are used to illustrate the present disclosure but are not intended to limit the scope of the present disclosure.

In some embodiments of the present disclosure, terms “first” and “second” are only used for descriptive purposes and cannot be understood as indicating or implying relative importance or implicitly specifying the quantity of indicated technical features. Therefore, a feature defined as “first” or “second” may explicitly or implicitly include one or more of the features. In the description of the present disclosure, “a plurality” means two or more, unless specifically limited otherwise.

In addition, in the present disclosure, directional terms such as “upper”, “lower”, “left” and “right” are defined with respect to the orientation in which components are schematically positioned in the accompanying drawings. It should be understood that the orientation terms are relative concepts and are used for relative description and clarification and may change correspondingly according to a change in a position in which a component is placed in the accompanying drawings.

In some embodiments of the present disclosure, unless otherwise explicitly specified and limited, the term “connection” should be understood in a broad sense. For example, the “connection” may be a fixed connection, a detachable connection, or an integral connection; and may be a direct connection or an indirect connection using an intermediate medium.

In some embodiments of the present disclosure, terms “include”, “comprise” or any other variations thereof are intended to cover a non-exclusive inclusion such that a process, method, article, or apparatus that includes a list of elements includes not only those elements, but also others not expressly listed elements, or elements inherent to such process, method, article, or apparatus. Without further limitation, an element defined by the statement “comprises a . . . ” does not exclude the presence of additional identical elements in a process, method, article or apparatus that includes that element.

In some embodiments of the present disclosure, words such as “exemplary” or “for example” are used to mean an example, illustration or description. Any embodiment or design described herein as “exemplary” or “for example” is not to be construed as preferred or advantageous over other embodiments or designs. Rather, a use of words such as “exemplary” or “for example” is intended to present related concepts in a concrete manner.

In some embodiments of the present disclosure, for the convenience of describing directions, preset directions are marked in FIG. 2, FIG. 3, FIG. 5, FIG. 7, FIG. 11, FIG. 12 and FIG. 13, and the preset directions are the interval setting directions of each antenna 21. It should be noted that the directional signs are only used to describe the present disclosure but are not used to limit the scope of the present disclosure.

Electronic devices are generally equipped with wireless devices such that the electronic devices can send and receive wireless signals through the wireless devices. In related art, due to the limitation of installation space, the distance between adjacent antennas in the wireless device is relatively close. This design will enhance the coupling of electromagnetic waves between antennas, reduce the isolation between antennas, and thus affect the performance of the wireless device.

In view of this, embodiments of the present disclosure provide an electronic device. The electronic device in some embodiments of the present disclosure may be a laptop, a tablet, a mobile phone, a computer host such as an All-in-One (AIO), a television, or a game console, which is not limited in some embodiments of the present disclosure.

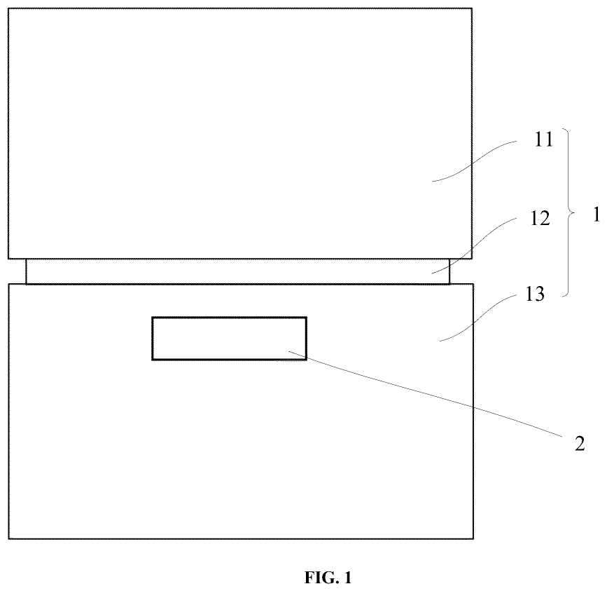

FIG. 1 is a schematic structural diagram of an example electronic device according to some embodiments of the present disclosure. As shown in FIG. 1, the electronic device includes a housing 1 and a wireless device 2, and the wireless device 2 is installed in the housing 1. The wireless device 2 in some embodiments of the present disclosure can reduce the coupling of electromagnetic waves between the antennas 21 such that the isolation between the antennas 21 can be improved, thereby improving the performance of the wireless device 2.

Refer to FIG. 1. In some embodiments, the electronic device may be a laptop, which includes a display system, a hinge system and an operating system. The housing 1 includes a first installation housing 11, a second installation housing 12 and a third installation housing 13. The display system is installed in the first installation housing 11, the hinge system is installed in the second installation housing 12, and the operating system is installed in the third installation housing 12. The first installation housing 11 and the third installation housing 12 are rotatably connected via a rotating shaft system.

In some embodiments of the present disclosure, the installation position of the wireless device 2 may be various. For example, the wireless device 2 can be installed in the first installation housing 11, the second installation housing 12, or the third installation housing 12, which is not limited in some embodiments of the present disclosure. Refer to FIG. 1. In some embodiments, the wireless device 2 is installed in the third installation housing 12.

In some embodiments of the present disclosure, the isolation of antenna 21 may refer to the ratio of the signal received by another antenna 21 to the signal of the transmitting antenna 21. That is, the less the signal transmitted by another antenna 21 is received by one antenna 21, the better the isolation between the two antennas 21, and the lower the interference.

Refer to FIG. 2, FIG. 7, FIG. 11 and FIG. 12. Embodiments of the present disclosure also provide a wireless device 2. The wireless device 2 may include an antenna 21 and an isolating member 22. There may be at least two antennas 21, and the at least two antennas 21 may be arranged at intervals along a preset direction. There may be at least two groups of isolating members 22, and the at least two groups of isolating members 22 may be arranged between two adjacent antennas 21. In addition, the at least two groups of isolating members 22 may be arranged at intervals along a preset direction to reduce the coupling of electromagnetic waves between the antennas 21.

The wireless device 2 provided in some embodiments of the present disclosure may include an antenna 21 and an isolating member 22. The antenna 21 may include at least two antennas, which can improve the performance and efficiency of the wireless device 2 during communication. The at least two antennas 21 may be arranged at intervals along a preset direction. Since each antenna 21 has its own radiation area, when the at least two antennas 21 are arranged at intervals along a preset direction, the radiation area of each antenna 21 will also increase, thereby reducing the interference between the antennas 21. Based on this, the wireless device 2 may include at least two groups of isolating members 22, and the at least two groups of isolating members 22 may be arranged between two adjacent antennas 21. When the antennas 21 are working, the isolating members 22 can reduce the coupling of electromagnetic waves between the antennas 21, thereby improving the isolation between the antennas 21. At least two groups of isolating members 22 may be arranged at intervals along a preset direction. In this way, the isolation effect of the isolating members 22 in the preset direction can be improved, thereby further reducing the coupling of electromagnetic waves between the antennas 21. Compared with the related art, the isolation between the antennas 21 is reduced due to the short distance between the adjacent antennas 21. In the wireless device provided in the present disclosure, at least two groups of isolating members 22 may be arranged between two adjacent antennas 21, and the at least two groups of isolating members 22 may be arranged at intervals along a preset direction. In this way, the at least two groups of isolating members 22 can reduce the coupling electromagnetic waves between the antennas 21, thereby improving the isolation between the antennas 21.

In some embodiments of the present disclosure, the number of antennas 21 may vary. For example, the number of antennas 21 can be two, three, or four, which is not limited in some embodiments of the present disclosure. Refer to FIG. 2, FIG. 7, FIG. 11 and FIG. 12. In some embodiments, there are two antennas 21, and the two antennas 21 are respectively a first antenna 21a and a second antenna 21b. The first antenna 21a may be a main antenna, and the second antenna 21b may be a secondary antenna; or the first antenna 21a may be a secondary antenna, and the second antenna 21b may be a main antenna; or the first antenna 21a and the second antenna 21b may both be main antennas, which is not limited in some embodiments of the present disclosure. In some embodiments of the present disclosure, the main antenna is mainly used to receive and send the main wireless signals, therefore, its performance is crucial to the quality of the network connection; the secondary antenna is used to assist the main antenna to improve the stability and reliability of the network connection.

In some embodiments of the present disclosure, the function of the antennas 21 is to receive and send wireless signals. Therefore, the structures of two adjacent antennas 21 can be the same or different, which is not limited in some embodiments of the present disclosure. Refer to FIG. 2, FIG. 7, FIG. 11 and FIG. 12. In some embodiments, two adjacent antennas 21 can be arranged with the same structure.

Refer to FIG. 2 and FIG. 7. In some embodiments, the wireless device 2 may further include a conductive member 23. The two adjacent antennas 21 may be electrically connected by the conductive member 23, and there may be a propagation space between the two adjacent antennas 21 for electromagnetic wave propagation. The isolating member 22 may include a first isolating structure 221, and the first isolating structure may include a first isolating member 2211 and a second isolating member 2212. The first isolating member 2211 may be used to reduce the coupling of electromagnetic waves in the propagation space, and the second isolating member 2212 may be used to reduce the coupling of electromagnetic waves on the conductive member 23.

In some embodiments, the wireless device 2 may further include a conductive member 23, and the two adjacent antennas 21 may be electrically connected via the conductive member 23 to improve the stability of the antennas 21 during operation. There may be a propagation space between two adjacent antennas 21 for electromagnetic wave propagation. In this way, when the antennas 21 are working, there may be two types of coupling paths of electromagnetic waves between the two adjacent antennas 21. In the first type, the electromagnetic waves between the antennas 21 may propagate in the propagation space and generate coupling in the propagation space; in the second type, the electromagnetic waves between the antennas 21 may propagate on the conductive member 23 and generate coupling on the conductive member 23. Based on this, the first isolating structure 221 may include a first isolating member 2211 and a second isolating member 2212. The first isolating member 2211 may be used to reduce the coupling of electromagnetic waves in the propagation space, and the second isolating member 2212 may be used to reduce the coupling of electromagnetic waves on the conductive member 23. In this way, under the compounding effect of the first isolating member 2211 and the second isolating member 2212, the coupling of electromagnetic waves between the antennas 21 can be further reduced, thereby further improving the isolation between the antennas 21.

In some embodiments of the present disclosure, the conductive member 23 may have various functions. For example, the conductive member 23 may be a grounding member, and two adjacent antennas 21 may be grounded at the same time through the grounding member. Alternatively, the conductive member 23 may also be a signal transmission member, and signals may be transmitted between two adjacent antennas 21 through the signal transmission member. In some embodiments, the conductive member 23 is a grounding member. In this way, the grounding member can introduce the electromagnetic interference generated by the antennas 21 into the ground, thereby improving the stability of the antennas 21 when in use.

The propagation space may be a three-dimensional space, and the propagation space may be located between two adjacent antennas 21 in a preset direction for electromagnetic waves propagation. In addition, the shape of the propagation space may be various. For example, the shape of the propagation space may be cylindrical, spherical, or other irregular shapes, which is not limited in some embodiments of the present disclosure.

In some embodiments of the present disclosure, the locations of the first isolating member 2211 and second isolating member 2212 can have many arrangements. For example, the first isolating member 2211 may be disposed in the propagation space, and the second isolating member 2212 may be disposed on the conductive member 23; or, both the first isolating member 2211 and the second isolating member 2212 may be disposed in the propagation space; or, both the first isolating member 2211 and the second isolating member 2212 may be disposed on the conductive member 23, which is not limited in some embodiments of the present disclosure.

Refer to FIG. 2 and FIG. 7. In some embodiments, the first isolating member 2211 may be disposed in the propagation space to reduce the coupling of electromagnetic waves in the propagation space, and the second isolating member 2212 may be disposed on the conductive member 23 to reduce the coupling of electromagnetic waves on the conductive member 23. When the first isolating member 2211 is disposed in the propagation space, the isolation effect of the first isolating member 2211 can be increased, thereby further reducing the coupling of electromagnetic waves in the propagation space. When the second isolating member 2212 is disposed on the conductive member 23, the isolation effect of the second isolating member 2212 can be increased, thereby further reducing the coupling of electromagnetic waves on the conductive member 23.

Refer to FIG. 2. In some embodiments, the second isolating member 2212 may be disposed in the propagation space, and the second isolating member 2212 and the first isolating member 2211 may be arranged alternately in a preset direction. When the second isolating member 2212 is disposed in the propagation space, the second isolating member 2212 can reduce the coupling of the electromagnetic waves on the conductive member 23 and the coupling of electromagnetic waves in the propagation space, thereby improving the isolation effect of the isolating member 22. As a result, the coupling of electromagnetic waves between the antennas 21 is further reduced. Based on this, the second isolating member 2212 and the first isolating member 2211 can be arranged alternately in a preset direction. In this way, the interference between the first isolating member 2211 and the second isolating member 2212 can be reduced, thereby further improving the isolation effect of the isolating member 22.

In some embodiments, to further reduce the interference between the first isolating member 2211 and the second isolating member 2212, in a preset direction, when the working wavelength of the antenna 21 is λ, the distance between the adjacent first isolating member 2211 and second isolating member 2212 may be greater than one eighth of λ.

In some embodiments, the first isolating member 2211 and the second isolating member 2212 may also be arranged in other manners in the preset direction. For example, refer to FIG. 7, in a preset direction, the first isolating members 2211 are arranged at intervals on a side close to the first antenna 21a, and the second isolating members 2212 are arranged at intervals on a side close to the second antenna 21b, which is not limited in some embodiments of the present disclosure.

In some embodiments of the present disclosure, each antenna 21 and the conductive member 23 may be arranged independently or centrally, which is not limited in some embodiments of the present disclosure. For example, when each antenna 21 and the conductive member 23 are arranged independently, the wireless device 2 may include a first mounting member and a second mounting member. The first mounting member and the second mounting member may be arranged at intervals, and each antenna 21 may be arranged on the first mounting member, and the conductive member 23 may be arranged on the second mounting member.

Refer to FIG. 2, FIG. 3 and FIG. 4. In some embodiments, each antenna 21 and the conductive member 23 may be centrally arranged. More specifically, the wireless device 2 may further include a dielectric substrate 24. At least two antennas 21 and the conductive member 23 may be disposed on the dielectric substrate 24. The dielectric substrate 24 may include a mounting area 241. The mounting area 241 may be located in the propagation space, and the first isolating member 2211 may be disposed in the mounting area 241. By disposing at least two antennas 21, the conductive member 23 and the first isolating member 2211 on the dielectric substrate 24, the integration of the wireless device 2 can be improved and the number of components in the wireless device 2 can be reduced, thereby facilitating the assembly of the wireless device 2. It should be noted that the dielectric substrate 24 may be a special substrate material having a high dielectric constant, thereby reducing the size of the circuit substrate and further reducing the size of the wireless device 2.

The antenna 21, the dielectric substrate 24, the conductive member 23, the first isolating member 2211 and the second isolating member 2212 may all be made of flexible materials such that the shape of the wireless device 2 can be changed based on the installation requirements, thereby improving the flexibility of the wireless device 2 during installation.

The function of the first isolating member 2211 is to reduce the coupling of electromagnetic waves in the propagation space, and the function of the second isolating member 2212 is to reduce the coupling of electromagnetic waves on the conductive member 23. Therefore, the structural design of the first isolating member 2211 and the second isolating member 2212 may vary. For example, the first isolating member 2211 may be a first electromagnetic wave reflector, and the second isolating member 2212 may be a second electromagnetic wave reflector. In this way, when the antennas 21 are working, the electromagnetic waves in the propagation space can change the propagation direction under the action of the first electromagnetic wave reflector, thereby reducing the coupling of the electromagnetic waves in the propagation space; the electromagnetic waves on the conductive member 23 can change the propagation direction under the action of the second electromagnetic waves reflector, thereby reducing the coupling of the electromagnetic waves on the conductive member 23.

In some embodiments, the first isolating member 2211 may generate a first isolation wave, the phase of the first isolation wave may be opposite to the phase of the electromagnetic wave coupled in the propagation space, thereby reducing the coupling of the electromagnetic waves in the propagation space; and/or, the second isolating member 2212 may generate a second isolation wave, the phase of the second isolation wave may be opposite to the phase of the electromagnetic wave coupled on the conductive member 23, thereby reducing the coupling of the electromagnetic wave on the conductive member 23. The first isolating member 2211 can generate the first isolation wave, and the second isolating member 2212 can generate the second isolation wave. When the antennas 21 are working, since the phase of the first isolation is opposite to the phase of the electromagnetic wave coupled in the propagation space, the electromagnetic wave in the propagation space will cancel out the first isolation wave, thereby improving the efficiency of reducing the coupling of electromagnetic waves in the propagation space. Further, since the phase of the second isolation wave is opposite to the phase of the electromagnetic wave coupled on the conductive member 23, the electromagnetic wave on the conductive member 23 will cancel out the second isolation wave, thereby improving the efficiency of reducing the coupling of the electromagnetic waves on the conductive member 23. It should be noted that in some embodiments of the present disclosure, both the first isolation wave and the second isolation wave are electromagnetic waves.

In some embodiments, when the first isolation wave reduces the coupling of electromagnetic waves in the propagation space, the frequency of the first isolation wave needs to be compatible with the frequency of the electromagnetic waves in the propagation space. In this way, the first isolation wave has a better effect when cancelling the electromagnetic waves in the propagation space. Correspondingly, when the second isolation wave reduces the coupling of the electromagnetic waves in the propagation space, the frequency of the second isolation wave needs to be compatible with the frequency of the electromagnetic waves on the conductive member 23. In this way, the second isolation wave has a better effect when cancelling the electromagnetic waves on the conductive member 23.

In some embodiments, to improve the working bandwidth of the isolating member 22, the difference between the frequency of the first isolation wave and the frequency of the second isolation wave may meet a preset value. Generally, the smaller the difference between the frequency of the first isolation wave and the frequency of the second isolation wave, that is, smaller the preset value, the larger the frequency range that the isolating member 22 can cover, thereby making the working bandwidth of the isolating member 22 wider. In some embodiments of the present disclosure, the value of the preset value can be set based on the design requirements. Therefore, the value of the preset value can vary. For example, the value of the preset value can be 0 Hz, 10 Hz, or 100 Hz, which is not limited in some embodiments of the present disclosure.

In some embodiments, the first isolating member 2211 may actively generate the first isolation wave, or may also passively generate the first isolation wave; correspondingly, the second isolating member 2212 may actively generate the second isolation wave, or may also passively generate the second isolation wave, which is not limited in some embodiments of the present disclosure.

In some embodiments, the first isolating member 2211 may be a first resonator, and/or the second isolating member 2212 may be a second resonator. When the first isolating member 2211 is a first resonator, duration the operation of the antenna 21, the electromagnetic waves generated by the antenna 21 propagate through the propagation space to the first resonator. In this way, the first resonator can passively generate the first isolation wave to reduce the coupling of the electromagnetic waves in the propagation space. When the second isolating member 2212 is the second resonator, duration the operation of the antenna 21, the electromagnetic waves generated by the antenna 21 propagate to the second resonator through the conductive member 23. In this way, the second resonator can passively generate the second isolation wave to reduce the coupling of the electromagnetic waves on the conductive member 23. The first isolating member 2211 can be the first resonator, and the second isolating member 2212 can be the second resonator. In this way, the structure of the first isolating member 2211 and the second isolating member 2212 can be relatively simple, and the stability of the first isolating member 2211 and the second isolating member 2212 can be improved.

In some embodiments of the present disclosure, the structures of the first isolating member 2211 and the second isolating member 2212 can vary. For example, when the first isolation wave is actively generated by the first isolating member 2211 and the second isolation wave is actively generated by the second isolating member 2212, the first isolating member 2211 may be a first electromagnetic wave transmitter and the second isolating member 2212 may be a second electromagnetic wave transmitter. When the first isolation wave is passively generated by the first isolating member 2211 and the second isolation wave is passively generated by the second isolating member 2212, the first isolating member 2211 may be a first resonator and the second isolating member 2212 may be a second resonator. When the first isolation wave is actively generated by the first isolating member 2211 and the second isolation wave is passively generated by the second isolating member 2212, the first isolating member 2211 may be the first electromagnetic wave transmitter and the second isolating member 2212 may be the second resonator. When the first isolation wave is passively generated by the first isolating member 2211 and the second isolation wave is actively generated by the second isolating member 2212, the first isolating member 2211 may be the first resonator and the second isolating member 2212 may be the second electromagnetic wave transmitter. The present disclosure does not limit the structures of the first isolating member 2211 and the second isolating member 2212.

In some embodiments, the first isolation wave may be passively generated by the first isolating member 2211, and the second isolation wave may be passively generated by the second isolating member 2212. At this time, the first isolating member 2211 is the first resonator, and the second isolating member 2212 is the second resonator.

The structural designs of the first resonator and the second resonator can very. For example, the first resonator may be a dielectric resonator, a coaxial resonator or a crystal resonator; correspondingly, the second resonator may be a dielectric resonator, a coaxial resonator or a crystal resonator, which is not limited in some embodiments of the present disclosure.

In some embodiments, the first resonator may be a first open resonant ring; and/or the second resonator may be a second open resonator ring. When the first resonator is a first open resonant ring, during the operation of the antenna 21, the electromagnetic wave generated by the antenna 21 propagates through the propagation space to the first open resonant ring to cause the first open resonant ring to generate an induced electromagnetic field and accumulate charges at the opening of the first open resonant ring to form an electric dipole moment, thereby generating the first isolation wave to reduce the coupling of the electromagnetic waves in the propagation space. When the second resonator is a second open resonant ring, during the operation of the antenna 21, the electromagnetic wave generated by the antenna 21 propagates to the second open resonant ring through the conductive member 23 to cause the second open resonant ring to generate an induced electromagnetic field and accumulate charges at the opening of the second open resonant ring to form an electric dipole moment, thereby generating the second isolation wave to reduce the coupling of electromagnetic waves on the conductive member 23. The first resonator can be the first open resonant ring, and the second resonator can be the second open resonant ring. In this way, the structures of the first isolating member 2211 and the second isolating member 2212 can be further simplified, thereby further improving the stability of the first isolating member 2211 and the second isolating member 2212.

In some embodiments, the first resonator may be the first open resonant ring, and the second resonator may be the second resonant ring.

In some embodiments of the present disclosure, the materials of the first open resonant ring and the second open resonant ring can vary. For example, the material of the first open resonant ring and the second open resonant ring may be electromagnetic metamaterials, copper, or nickel, which is not limited in some embodiments of the present disclosure. It should be noted that electromagnetic metamaterials, also know as metamaterials, are a type of artificial composite structure or composite material with extraordinary physical properties that natural material do not have.

In some embodiments, the first open resonant ring and the second open resonant ring may both be made of electromagnetic metamaterials. In this way, the first open resonant ring and the second open resonant ring have the following advantages. First, the open resonant ring made of electromagnetic metamaterials can be customized by adjusting its geometry, size, material properties and other factors to realize the desired electromagnetic performance over a wide frequency range, with high flexibility. Second, the open resonant ring made of electromagnetic metamaterials is relatively small in size, which can reduce the space occupied by the first open resonant ring and the second open resonant ring, which facilitates the miniaturization design of the wireless device 2.

In some embodiments, to facilitate the arrangement of the second open resonant ring, refer to FIG. 5 and FIG. 6, a hollow structure is provided on the conductive member 23, and the hollow structure forms the second open resonant ring. In this way, the first open resonant ring and the second open resonant ring can be integrally arranged on the conductive member 23, and there is no need to separately arrange the second open resonant ring. In addition, the first open resonant ring can be arranged on the dielectric substrate 24 by bonding, clamping, or fastener connection, which is not limited in some embodiments of the present disclosure.

In some embodiments of the present disclosure, when designing the first open resonant ring and the second open resonant ring, there may be a need to first determine the operating frequency of the antenna 21, and then determine the frequencies of the first isolation wave and the second isolation wave based on the operating frequency of the antenna 21. In this way, the first isolation wave can better offset the electromagnetic waves coupled in the propagation space, and the second isolation wave can better offset the electromagnetic waves coupled on the conductive member 23. The frequency of the first isolation wave may be related to the shape, size and number of the first open resonant ring, and the frequency of the second isolation wave may be related to the shape, size and number of the second open resonant ring. Therefore, after determining the frequencies of the first isolation wave and the second isolation wave, there may be a need to determine the shape, size and number of the first open resonant ring based on the frequency of the first isolation wave, and determine the shape, size and number of the second open resonant ring based on the frequency of the second isolation wave. After determining the shape, size and number of the first open resonant ring and the second open resonant ring, it may be confirmed by computer electromagnetic simulation software or by experiments, which is not limited in some embodiments of the present disclosure.

In some embodiments of the present disclosure, the shapes of the first open resonant ring and the second open resonant ring can vary. For example, refer to FIG. 3, the shape of the first open resonant ring is a triangular open resonant ring. The triangular open resonant ring includes a triangular ring, then end corners of the triangular ring are connected with a metal wire. Or, refer to FIG. 8, the first open resonant ring is in the shape of a square open resonant ring. The square open resonant ring includes an inner ring 22111 and an outer ring 22112. The inner ring 22111 and the outer ring 22112 are connected by a metal wire. Or, refer to FIG. 9, the first open resonant ring is a circular open resonant ring. Or, refer to FIG. 10, the first open resonant ring is a rectangular open resonant ring. Correspondingly, the shape of the second open resonant ring can be a triangular open resonant ring; or, the shape of the second open resonant ring can be a square open resonant ring; or, the shape of the second open resonant ring can be a circular open resonant ring; or, the shape of the second open resonant ring can be a rectangular open resonant ring. The present disclosure does not limit the shapes of the first open resonant ring and the second open resonant ring. It should be noted that the shapes of the first open resonant ring and the second open resonant ring can be the same or different, which is not limited in some embodiments of the present disclosure.

In some embodiments of the present disclosure, the sizes of the first open resonant ring and the second open resonant ring may be determined based on design requirements, therefore, the sizes of the open resonant ring and the open resonant ring can vary. For example, the length of the first open resonant ring may be 6 mm, and the width may be 6 mm; or the length of the first open resonant ring may be 6.3 mm, and the width may be 6.3 mm; or, the length of the first open resonant ring may be 6.5 mm, and the width may be 6.5 mm. Correspondingly, the length of the second open resonant ring may be 6 mm, and the width may be 6 mm; or, the length of the second open resonant ring may be 6.3 mm, and the width may be 6.3 mm; or, the length of the second open resonant ring may be 6.5 mm, and the width may be 6.5 mm. The present disclosure does not limit the sizes of the first open resonant ring and the second open resonant ring. It should be noted that the length and width of the first open resonant ring and the second open resonant ring may also be set to different values. For example, the length of the first open resonant ring may be 5 mm and the width may be 4 mm; or, the length of the second open resonant ring may be 5 mm and the width may be 6 mm, which is not limited in some embodiments of the present disclosure. In addition, the sizes of the first open resonant ring and the second open resonant ring can be the same or different, which is not limited in some embodiments of the present disclosure.

In some embodiments, when the sizes of the first open resonant ring and the second open resonant ring increase, the operating frequencies of the first open resonant ring and the second open resonant ring may shift toward the low frequency band; when the sizes of the first open resonant ring and the second open resonant ring reduce, the operating frequencies of the first open resonant ring and the second open resonant ring may shift toward the high frequency band.

Refer to FIG. 1, in some embodiments, the first open resonant ring and the second open resonant ring are arranged in the same shape, and the first open resonant ring and the second open resonant ring are arranged in the same size. Since the first open resonant ring is a patch structure, the second open resonant ring is formed by a hollow structure. At this time, the difference between the frequency of the first isolation wave generated by the first open resonant ring and the frequency of the second isolation wave generated by the second open resonant ring is small and can meet the preset value.

In some embodiments of the present disclosure, the number of the first open resonant ring and the second open resonant ring can also vary. For example, the number of the first open resonant rings may be two, three, or four; correspondingly, the number of the second open resonant ring may be two, three, or four, which is not limited in some embodiments of the present disclosure. It should be noted that the number of the first open resonant ring and the second open resonant ring can be the same or different, which is not limited in some embodiments of the present disclosure. Refer to FIG. 1, in some embodiments, the number of the first open resonant ring and the number of the second open resonant ring are both two. In this way, the isolation effect of the isolating member 22 can be ensured and the isolating member 22 can be prevented from occupying a large space.

Refer to FIG. 11 and FIG. 12. In some embodiment, the isolating member 22 may also include a second isolating structure 222, and there may be at least two second isolating structures 222 arranged at intervals along a preset direction. When the antennas 21 are working, the second isolating structure 222 can reduce the coupling of the electromagnetic waves between the antennas 21, thereby improving the isolation between the antennas 21. At least two groups of second isolating structures 222 may be arranged at intervals along a preset direction. In this way, the isolation effect of the isolating member 22 in the preset direction can be improved, thereby further reducing the coupling of electromagnetic waves between the antennas 21.

In some embodiments of the present disclosure, the second isolating structure 222 may be disposed at various positions. For example, when two adjacent antennas 21 are electrically connected by a conductive member 23 and there is a propagation space for electromagnetic waves propagation between the two adjacent antennas 21, refer to FIG. 11, a second isolating structure 222 is disposed in the propagation space to reduce the coupling of the electromagnetic waves in the propagation space. Or, refer to FIG. 12 and FIG. 13, the second isolating structure 222 is also disposed in the propagation space and on the conductive member 23 to reduce coupling of electromagnetic waves on the conductive member 23.

In some embodiments of the present disclosure, the structure of the second isolating structure 222 can vary. For example, the second isolating structure 222 may be a third electromagnetic wave transmitter. When the antennas 21 are working, the third electromagnetic wave transmitter may actively generate a third isolation wave to reduce the coupling of electromagnetic waves between the antennas 21. The second isolating structure 222 may also be a third resonator. When the antennas 21 are working, the electromagnetic waves generated by the antennas 21 may be transmitted to the third resonator for the third resonator to generate a third isolation wave to reduce the coupling of the electromagnetic waves between the antennas 21.

In some embodiments of the present disclosure, the structural design of the third resonator can vary. For example, the third resonator may be a dielectric resonator, a coaxial resonator, or a crystal resonator, which is not limited in some embodiments of the present disclosure.

In some embodiments, the third resonator may be a third open resonant ring. When the third resonator is a third open resonant ring, during the operation of the antennas 21, the electromagnetic waves generated by the antennas 21 propagate to the third open resonant ring to cause the third open resonant ring to generate an induced electromagnetic field, and accumulate charges at the opening of the third open resonant ring to form an electric dipole moment, thereby generating a third isolation wave to reduce the coupling of electromagnetic waves between the antennas 21.

In some embodiments of the present disclosure, the material of the third open resonant ring can vary. For example, the material of the third open resonant ring maybe an electromagnetic metamaterial, copper, or nickel, which is not limited in some embodiments of the present disclosure.

In some embodiments, when the wireless device 2 further includes the dielectric substrate 24, the dielectric substrate 24 may have a mounting area 241. The mounting area 241 may be located in the propagation space, and the third open resonant ring may be arranged in the mounting area 241 of the dielectric substrate 24. The third open resonant ring may be set on the dielectric substrate 24 by bonding, clamping, fastening, etc., which is not limited in some embodiments of the present disclosure.

In some embodiments, the material of the third open resonant ring may be electromagnetic metamaterial. In this way, the third open resonant ring can have the following advantages. First, the open resonant ring made of electromagnetic metamaterials can be customized by adjusting its geometry, size, material properties and other factors to realize the desired electromagnetic performance over a wide frequency range, with high flexibility. Second, the open resonant ring made of electromagnetic metamaterials is relatively small in size, which can reduce the space occupied by the third open resonant ring, which facilitates the miniaturization design of the wireless device 2.

In some embodiments, when the third open resonant ring is disposed on the dielectric substrate 24, the third open resonant ring may be disposed on the dielectric substrate 24 by bonding, clamping, fastening, etc., which is not limited in some embodiments of the present disclosure. When the third open resonant ring is arranged on the dielectric substrate 24, a hollow structure may be arranged on the conductive member 23, and the hollow structure can form the third open resonant ring.

In some embodiments, when designing the third open resonant ring, there may be a need to first determine the operating frequency of the antennas 21, and then determine the frequency of the third isolation wave based on the operating frequency of the antennas 21. In this way, the third isolation wave can better offset the electromagnetic waves between the antennas 21. The frequency of the third isolation wave may be related to the shape, size and number of the third open resonant ring. Therefore, after determining the frequency of the third isolation wave, there may be a need to determine the shape, size and number of the third open resonant ring based on the frequency of the third isolation wave. After determining the shape, size and number of the third open resonant ring, it may be confirmed by computer electromagnetic simulation software or by experiments, which is not limited in some embodiments of the present disclosure.

In some embodiments of the present disclosure, the shape of the third open resonant ring can vary. For example, the third open resonant ring may be a square open resonant ring, a triangular open resonant ring, a circular open resonant ring, or a rectangular open resonant ring, which is not limited in some embodiments of the present disclosure. It should be noted that the shape of the third open resonant ring may be the same as that of the first open resonant ring, or may be different from that of the first open resonant ring.

In some embodiments, the size of the third open resonant ring may be determined based on design requirements, and the size of the third open resonant ring may vary. For example, the length of the third open resonant ring may be 6 mm and the width may be 6 mm; or, the length of the third open resonant ring may be 6.3 mm and the width may be 6.3 mm; or, the length of the third open resonant ring may be 6.5 mm and the width may be 6.5 mm. It should be noted that the length and width of the third open resonant ring may also be set to different values. For example, the length of the third open resonant ring may be 4 mm, and the width may be 6 mm, which is not limited in some embodiments of the present disclosure.

In some embodiments, when the size of the third open resonant ring increases, the operating frequency of the third open resonant ring may shift toward the low frequency band;

when the size of the third open resonant ring reduces, the operating frequency of the third open resonant ring may shift toward the high frequency band. Refer to FIG. 14, under the premise that the number and shape of the large-sized third open resonant ring, the medium-sized third open resonant ring and the small-sized third open resonant ring are consistent, the present disclosure provides a comparison of the isolation effects of a large-sized third open resonant ring, a medium-sized third open resonant ring and a small-sized third open resonant ring. The horizontal axis in FIG. 14 is the operating frequency of the antenna 21, and the vertical axis is the isolation between the antennas 21. Curve S1 represents the isolation effect of the large-sized third open resonant ring, curve S2 represents the isolation effect of the medium-sized third open resonant ring, and curve S3 represents the isolation effect of the small-sized third open resonant ring. It can be seen that as the operating frequency of the antenna 21 increases, the isolation effect of the small-sized third open resonant ring is better than the isolation effect of the medium-sized third open resonant ring, and the isolation effect of the medium-sized third open resonant ring is better than the isolation effect of the large-sized third open resonant ring.

In some embodiments, to reduce the space occupied by the third open resonant ring, the size of the third open resonant ring can be much smaller than the working wavelength of the antenna 21.

In some embodiments of the present disclosure, the number of the third open resonant ring can vary. For example, the number of the third open resonant rings may be two, five, or eight, which is not limited in some embodiments of the present disclosure. In some embodiments, the number of the third open resonant ring is eight.

In some embodiments, the dielectric substrate 24 and the third open resonant ring may both be made of flexible materials, such that the shape of the wireless device 2 can be changed based on installation requirements, thereby improving the flexibility of the wireless device 2 during installation.

In some embodiments, the isolating member 22 may include only the first isolating structure 221, or only the second isolating structure 222, or may include both the first isolating structure 221 and the second isolating structure 222, which is not limited in some embodiments of the present disclosure.

Refer to FIG. 15. The present disclosure provides a comparison of the isolation effects of the first isolating structure 221 and the second isolating structure 222. The horizonal axis in FIG. 15 is the operating frequency of the antenna 21, and the vertical axis is the isolation between the antennas 21. Curve S4 represents the isolation effect of the first isolating structure 221, and curve S5 represents the isolation effect of the second isolating structure 222. It can be seen that when the operating frequency of the antenna 21 is low, the isolation effect of the second isolating structure 222 is better than the isolation effect of the first isolating structure 221, but as the operating frequency of the antenna 21 increases, the isolation effect of the first isolating structure 221 is better than the isolation effect of the second isolating structure 222. In this way, when designing the wireless device 2, the structure of the isolating member 22 can be determined based on the operating frequency of the antenna 21.

The sequential numbers of some embodiments of the present disclosure are for description purpose only, and they do not denote preference of the embodiments. The above descriptions are merely example embodiments of the present disclosure, and are not intended to limit the scope of the present disclosure. Any equivalent modification made to the structure or processes based on content of this specification and the accompanying drawings for direct or indirect use in other related technical fields shall all fall within the scope of the present disclosure.

What is claimed is:

1. A wireless device comprising:
at least two antennas, the at least two antennas being arranged at intervals along a preset direction; and
at least two groups of isolating members, the at least two groups of isolating members being arranged between two adjacent antennas, the at least two groups of isolating members being arranged at intervals along the preset direction to reduce coupling of electromagnetic waves between the at least two antennas.

2. The wireless device of claim 1 further comprising:
a conductive member, the two adjacent antennas being electrically connected through the conductive member, and there is a propagation space between the two adjacent antennas for the electromagnetic waves to propagate, wherein:
the isolating member includes a first isolating structure, the first isolating structure including a first isolating member and a second isolating member, the first isolating member being used to reduce the coupling of the electromagnetic waves in the propagation space, the second isolating member being used to reduce the coupling of the electromagnetic waves on the conductive member.

3. The wireless device of claim 2, wherein:
the first isolating member is disposed in the propagation space to reduce the coupling of the electromagnetic waves in the propagation space, and the second isolating member is disposed on the conductive member to reduce the coupling of the electromagnetic waves on the conductive member.

4. The wireless device of claim 3, wherein:
the second isolating member is disposed in the propagation space, and the second isolating member and the first isolating member are arranged alternately in the preset direction.

5. The wireless device of claim 2 further comprising:
a dielectric substrate, at least two antennas and the conductive member being disposed on the dielectric substrate, the dielectric substrate including a mounting area, the mounting area being located in the propagation space, the first isolating member being disposed in the mounting area.

6. The wireless device of claim 2, wherein:
the first isolating member is configured to generate a first isolation wave, a phase of the first isolation wave being opposite to a phase of the electromagnetic waves coupled in the propagation space to reduce the coupling of the electromagnetic waves in the propagation space; and/or,
the second isolating member is configured to generate a second isolation wave, a phase of the second isolation wave being opposite to the phase of the electromagnetic waves coupled to the conductive member to reduce the coupling of the electromagnetic waves on the conductive member.

7. The wireless device of claim 6, wherein:
a difference between a frequency of the first isolation wave and a frequency of the second isolation wave meets a preset value.

8. The wireless device of claim 2, wherein:
the first isolating member is a first resonator, and/or the second isolating member is a second resonator.

9. The wireless device of claim 8, wherein:
the first resonator is a first open resonant ring, and/or the second resonator is a second open resonant ring.

10. The wireless device of claim 1, wherein:
the isolating member includes a second isolating structure, at least two second isolating structures being arranged at intervals along the preset direction.

11. An electronic device comprising:
a housing; and
a wireless device, the wireless device including:
at least two antennas, the at least two antennas being arranged at intervals along a preset direction; and
at least two groups of isolating members, the at least two groups of isolating members being arranged between two adjacent antennas, the at least two groups of isolating members being arranged at intervals along the preset direction to reduce coupling of electromagnetic waves between the at least two antennas.

12. The electronic device of claim 11, wherein the wireless device further includes:
a conductive member, the two adjacent antennas being electrically connected through the conductive member, and there is a propagation space between the two adjacent antennas for the electromagnetic waves to propagate; and
the isolating member includes:
a first isolating structure, the first isolating structure including a first isolating member and a second isolating member, the first isolating member being used to reduce the coupling of the electromagnetic waves in the propagation space, the second isolating member being used to reduce the coupling of the electromagnetic waves on the conductive member.

13. The electronic device of claim 12, wherein:
the first isolating member is disposed in the propagation space to reduce the coupling of the electromagnetic waves in the propagation space, and the second isolating member is disposed on the conductive member to reduce the coupling of the electromagnetic waves on the conductive member.

14. The electronic device of claim 13, wherein:
the second isolating member is disposed in the propagation space, and the second isolating member and the first isolating member are arranged alternately in the preset direction.

15. The electronic device of claim 12, wherein the wireless device further includes:
a dielectric substrate, at least two antennas and the conductive member being disposed on the dielectric substrate, the dielectric substrate including a mounting area, the mounting area being located in the propagation space, the first isolating member being disposed in the mounting area.

16. The electronic device of claim 12, wherein:
the first isolating member is configured to generate a first isolation wave, a phase of the first isolation wave being opposite to a phase of the electromagnetic waves coupled in the propagation space to reduce the coupling of the electromagnetic waves in the propagation space; and/or,
the second isolating member is configured to generate a second isolation wave, a phase of the second isolation wave being opposite to the phase of the electromagnetic waves coupled to the conductive member to reduce the coupling of the electromagnetic waves on the conductive member.

17. The electronic device of claim 16, wherein:
a difference between a frequency of the first isolation wave and a frequency of the second isolation wave meets a preset value.

18. The electronic device of claim 12, wherein:
the first isolating member is a first resonator, and/or the second isolating member is a second resonator.

19. The electronic device of claim 18, wherein:
the first resonator is a first open resonant ring, and/or the second resonator is a second open resonant ring.

20. The electronic device of claim 11, wherein:
the isolating member includes a second isolating structure, at least two second isolating structures being arranged at intervals along the preset direction.
